(19) United States
(12) Patent Application Publication
(10) Pub. No.: US 2016/0013694 A1
(43) Pub. Date: Jan. 14, 2016

(54) DEEPLY NESTED COIL ARRAYS FOR MOTORS AND GENERATORS

(71) Applicant: Metropolitan Industries, Inc., Romeoville, IL (US)

(72) Inventor: John Brian Dempster, Floyds Knobs, IN (US)

(21) Appl. No.: 14/328,261

(22) Filed: Jul. 10, 2014

(51) Int. Cl. H02K 3/28

(52) U.S. Cl. CPC H02K 3/28

(57) ABSTRACT

An apparatus including at least first and second coils wherein, the combined shape of one coil with offset joggles nests with a second coil without offset joggles. A plurality of the combined first and second coils can be configured to define one of an annularly shaped stator, or a cylindrically shaped stator for a motor or a generator.

### FIELD

The field of the invention relates to electric motors and generators and more particularly synchronous electric motors and generators.

### BACKGROUND

Electric motors and generators are generally known. In each case, a magnetic pole piece on one of a rotor or stator attracts or repels a similar pole piece on the other of the rotor or stator in order to cause a rotational or other useful force.

A small air gap exists between the stator and rotor. In order to reduce this air gap, one known design uses a series of overlapping coils with the ends of alternating coils tilted upwards. This allows the connecting or center portions of all of the coils to occupy the same radial space around the rotor.

Another design, for a pancake motor, has relied upon the use of a set of overlapping coils where the opposing ends of each coil are tilted away from the adjacent coil.

### BRIEF DESCRIPTION OF THE DRAWINGS

FIG. 1 illustrates a block diagram of an actuator system in accordance herewith;

FIGS. 2A-B depicts examples of motor actuators that may be used with the system of FIG. 1;

FIG. 3 depicts a coil array that may be used with the system of FIG. 1;

FIG. 4 depicts another coil array that may be used with the system of FIG. 1;

FIG. 5 depicts a portion of the coil array of FIG. 3;

FIG. 6 depicts a side view of one of the coils of FIG. 5;

FIG. 7 depicts a perspective view of a coil with joggles that may be used with the motor actuator of FIG. 2A;

FIG. 8 depicts a perspective view of a flat coil that may be used with the motor actuator of FIG. 2A; and

FIG. 9 depicts a perspective view of a coil with joggles that may be used with the motor actuator of FIG. 4.

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

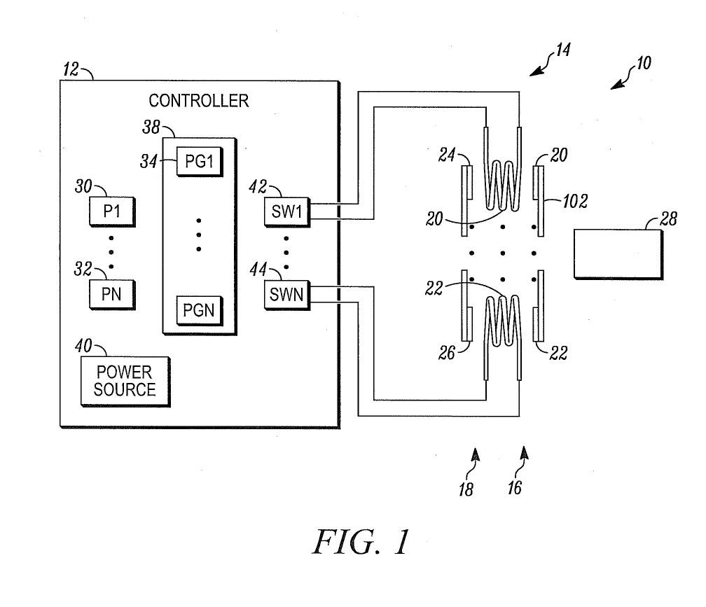

FIG. 1 is a simplified block diagram of an actuator system 10 shown generally in accordance with an illustrated embodiment of the invention. Included within the actuator system may be an electronic commutation controller 12 and an actuator system 14.

The actuator system 14 may include a stator 16 and a moveable actuator structure 18. The moveable actuator structure 18 includes any number and combination of required saturable magnetic circuit elements, permanent magnets or electro magnets 24, 26 and an output shaft 28. Similarly, the stator 16 includes a coil array including a number of coils 20, 22, each including one or more loops of a conductive metal (e.g., copper).

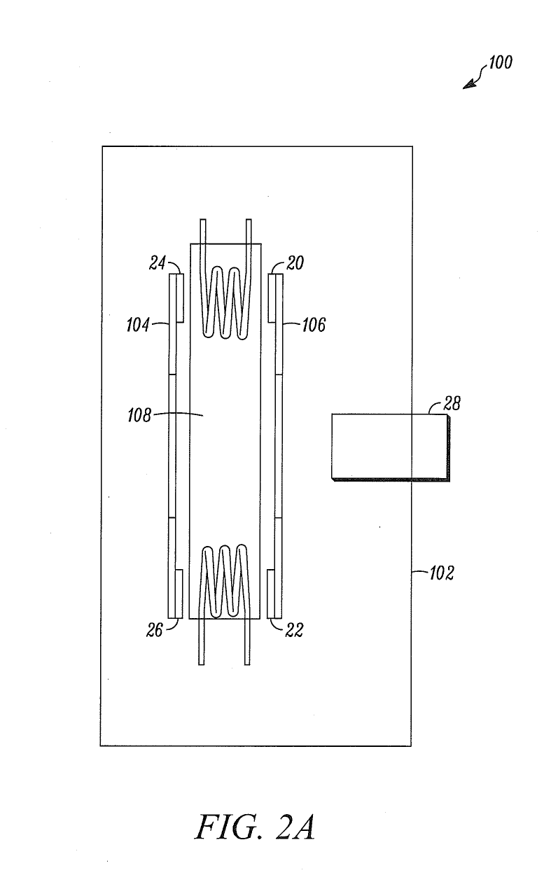

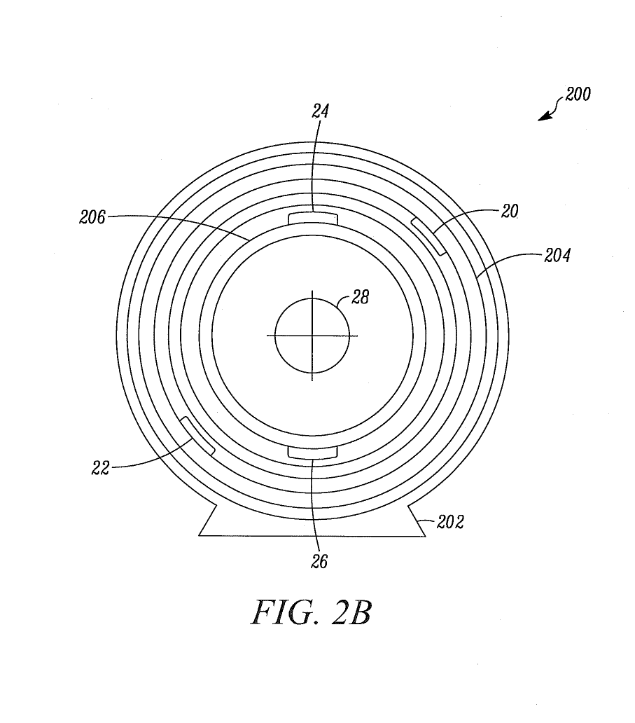

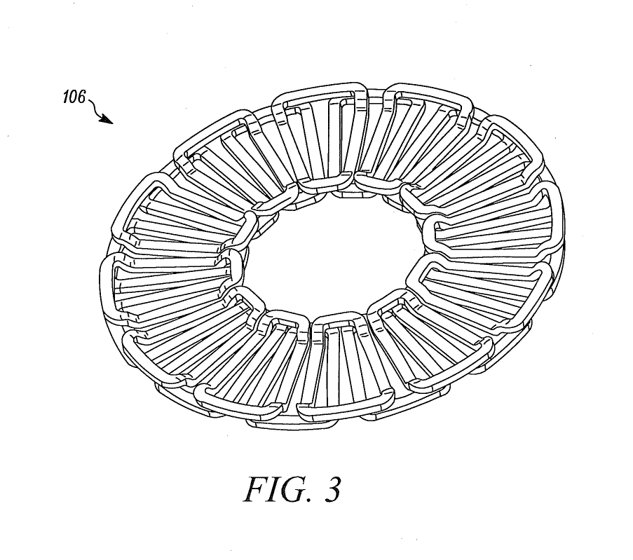

FIGS. 2A-B depict simplified examples of the actuator system of FIG. 1. For example, the actuator system shown in FIG. 1 may be embodied as a pancake motor 100 as shown in FIG. 2A. The pancake motor may include a housing 102 that supports the stator and actuator structure. The stator may include one or more coil arrays 106, 108 embodied in the form of a stationary disk with the coils 20, 22 of FIG. 1 disposed along an outer periphery (i.e., the annulus) of the disk, as shown in FIG. 3.

Similarly, the actuator of FIG. 1 may be embodied as a rotating disk 104 supported by a shaft 28 as shown in FIG. 2A. The rotor disk and shaft may be supported by the housing using one or more rotary bearings. Any number and combination of required saturable magnetic circuit elements, permanent magnets or electro magnets may be disposed along an outer periphery on the sides of the disk proximate the coils.

Similarly, the actuator system of FIG. 1 may be embodied as a radial gap motor 200 shown in FIG. 2B. The motor 200 may include a housing 202 that supports stator 204 with coils such as 20, 22. A cylindrical rotor 206 (actuator system) is also supported by housing 202 on one or both ends via rotary bearings. In this case, any number and combination of required saturable magnetic circuit elements, permanent magnets or electro magnets 24, 26 are mounted to the outside surface of the inner rotor 206.

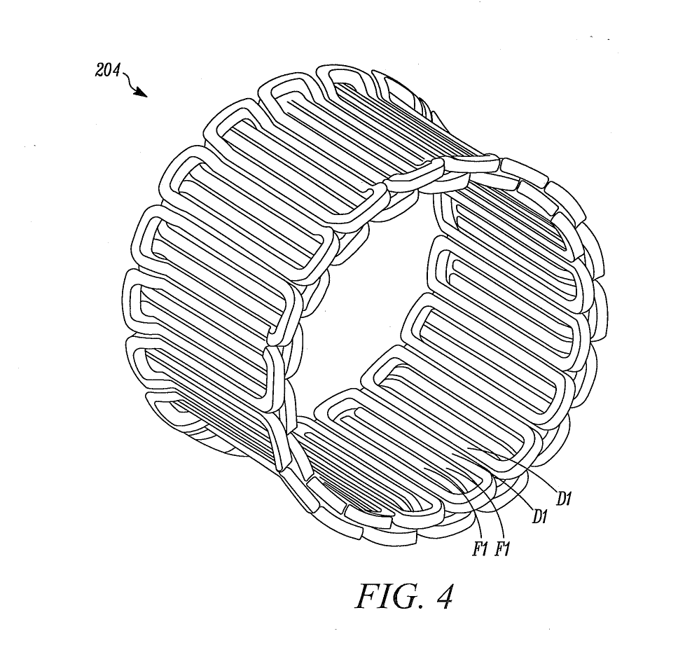

The stator 204 of the radial gap motor has the shape of a cylindrical shell (FIG. 4) that surrounds the cylindrical rotor. The coils are mounted so the electrical path is mostly perpendicular with the magnets magnetic field which is mostly in the radial direction.

The coils may each be energized by one of a corresponding number of switches 42, 44 (FIG. 1) that intermittently couple each of the coils to a power source 40. The switches, in turn, may be activated via one or more processor apparatus (processors) 30, 32, each operating under control of one or more computer programs 34, 36 loaded from a non-transitory computer readable medium (memory) 38. This switching of coils could actuate a single phase device or a device with any number of phases.

In general, the stator of the actuator of FIG. 1 is free of any required saturable magnetic circuit elements, such as an iron core or steel laminations. Accordingly, the conductors of the coils interact with the magnets primarily via Lorenz forces.

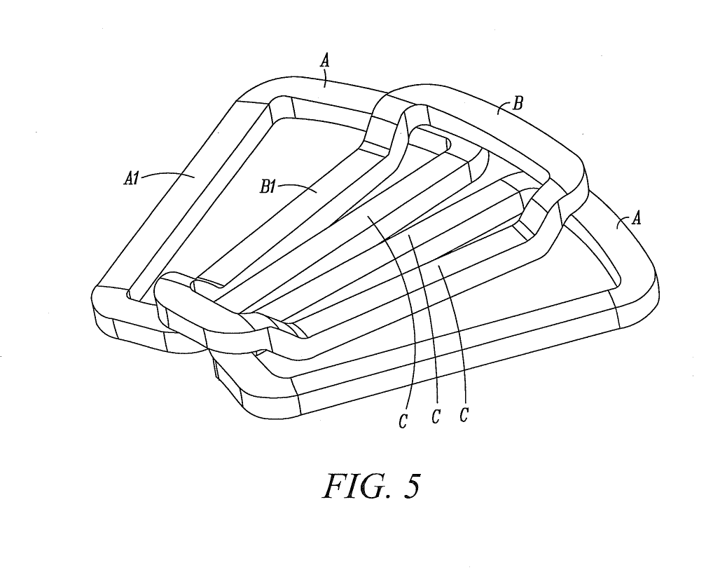

FIG. 5 shows an example of three coils ABA of the coil array 106 of FIG. 3. The corresponding set of three coils from FIG. 4 would be the same except that the longitudinal sides would be mutually parallel.

It should be understood that each of the coils include a number of loops of a conductive metal. The two leads needed for connecting the respective coils to the switches of FIG. 1 are not shown for simplicity.

As shown in FIGS. 3, 4 and 5, the stator includes a first set of coils and a second set of coils. The first set of coils (labeled A in FIG. 5) are flat, see side Al for example. The coils of the second set (labeled B in FIG. 5) each include two respective joggles in each longitudinal side, such as B1, of the coil.

In general, the coils include a set of longitudinal conductors on each of two, opposing sides of each coil and a set of end conductors on each of the two ends that connect the longitudinal conductors. The longitudinal conductors (called working conductors) are oriented perpendicular to the direction of movement or travel of the adjacent magnets. While current flows through the entire coil, it is only the current in the working conductors that contributes a lateral force to the actuator (i.e., torque to the rotor). The non-working, or end conductors, merely complete the circuit between working conductors.

In general, the joggle on each end of the working conductors allows a deeply nested coil array in devices, such as motors and generators, where the offset joggle at each end of every second coil (i.e., of the second set) allows the coil array to nest in such a way that the working lengths of each coil lay in a common plane. This coil array geometry allows a rotor and stator to have a small magnetic air gap. The smaller magnetic air gap produces higher flux forces and higher lateral forces in a device that takes advantage of Lorentz forces to produce useful work.

The joggles affect the shape of every second coil (see FIGS. 3-5) which allows these coils to deeply nest with standard coils which do not utilize the offset end joggles. Coil arrays described herein could be a simple bonded structure, over molded structure, or any other structure to secure the coil array's shape and transfer loads.

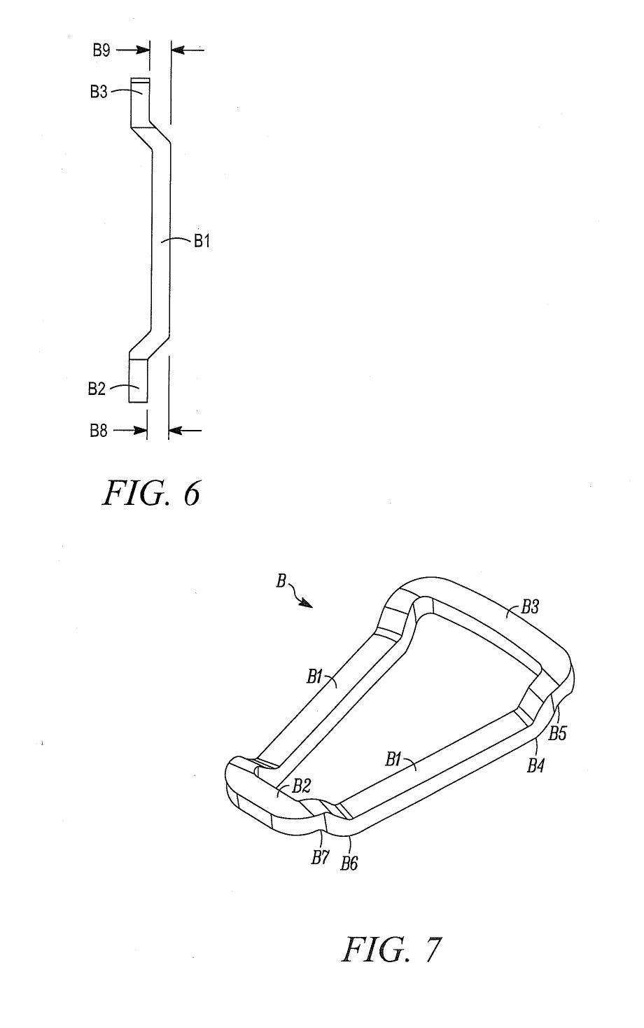

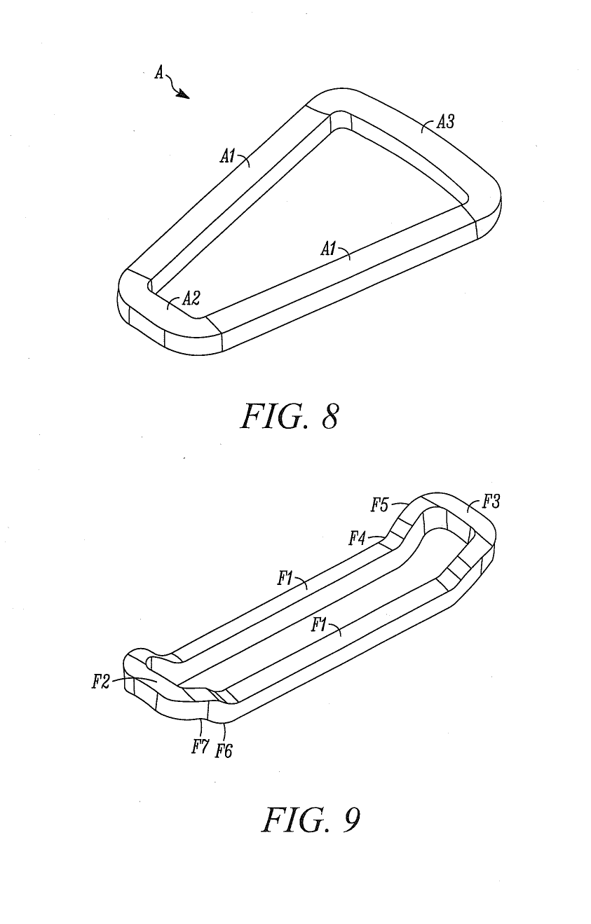

FIG. 7 depicts a coil B for axial gap devices which has deep offset end joggles. In FIG. 7, reference B1 refers to the working sections of the coil. This is the area of the coil which produces work when electrical current is passed through the coil's conductors and these conductors are within a perpendicular or somewhat perpendicular magnetic field. Bends B4 and B5 form the offset joggle at the coil's outer end turn B3. Bends B6 and B7 form the offset joggle at the coil's inner end turn B2. This offset joggle is shown formed with two bends but any two or more bends could be used. Referring to FIG. 6, reference B9 shows that the deep offset joggle is equal to or greater than A1's axial height. It is this deep offset joggle at each end which allows the nesting of this coil with standard coils such as coil A shown in FIG. 8.

FIG. 5 shows how the nesting of these coils allows working lengths A1 and B1 to lie in the common plane that is also occupied by lengths C. The coil sub-array of FIG. 5 can be repeated to form a full circular coil array 106 shown in FIG. 3. One or more of the coils of FIG. 3 could be omitted to facilitate the applications requirements. Also, the coil array of FIGS. 3 and 5 could be broken into two or more sections to facilitate an application's requirements such as for breaking a large stator into manageable parts for assembly around a large rotor.

FIG. 3 shows how the coil array geometry forms a coil array in which one side is flat without protruding coil offset bends. This facilitates assembly into the pancake motors shown in FIG. 2A.

FIG. 9 shows a coil array for radial gap devices which has deep offset end joggles. Once again referring to FIG. 4, F1 refers to the working section of the coil. This area of the coil produces work when electrical current is passed through the coil's conductors and these conductors are within a perpendicular or somewhat perpendicular magnetic field. Bends F4 and F5 form the offset joggles adjacent the coil's end connector F3. Bends F6 and F7 form the offset joggle at the coil's other end connector F2. This offset joggle is shown formed with two bends of approximately 45 degrees but any two or more bends could be used. FIG. 9 shows the deep offset joggle which is equal or greater to the overlapped coil's radial height. It is this deep offset joggle at each end which allows the nesting of this coil with standard flat coils such as that shown in FIG. 4.

FIG. 4 shows how the nesting of these coils allows working lengths D1 and Fl to lie equidistant from the center axis of the rotor. The working lengths F1, D1 form an interior cylindrical surface which surrounds the rotor 206. The joggles on each end of the coils with working lengths F1 are oriented to bend away from the rotor to provide the deeply nested structure hereof. As above, one or more coils could be omitted to facilitate an application's requirements. Also the array coil of FIG. 4 could be broken into two or more sections to facilitate installation.

FIG. 4 shows how this coil array geometry forms a coil array with one radial side having a flat surface without coil offset protrusions. This coil array allows the working conductors to be located closer to the magnets than previous designs.

In summary, the system includes a rotor or 2 rotors, and a stator, including a coil array that further includes first and second sets of coils, each including a pair of working conductors on opposing longitudinal sides of the coil and respective end conductors that join opposing ends of the working conductors. The first and second sets of coils are arranged along a surface of the rotor in a partially overlapping relationship with mutually parallel working conductors and with each of the working conductors of the second set of coils disposed between and in a common plane with the pairs of working conductors on opposing sides of each of a pair of directly adjacent coils of the first set of coils. Each of the working conductors of the second set of coils has a joggle on opposing ends of the working conductors. The joggle offsets the respective ends of each of the second set of coils. The offset provides clearance. Further, the stator is free of any required saturable magnetic circuit elements.

In another embodiment, the system includes an actuator and a stator without any required saturable magnetic circuit elements. The stator including a coil array, the coil array including a first plurality of coils adjacent the actuator each coil defined by conductors residing within a single plane. A second plurality of coils wherein members of the second plurality nest with respective members of the first plurality. Each of the members of the first and second plurality of coils includes a pair of working conductors on opposing longitudinal sides of the coil and a pair of end conductors that each join respective ends of the working conductors. Each member of the second plurality of coils includes a respective joggle on each of the opposing ends of the working conductors.

From the foregoing, it will be observed that numerous variations and modifications may be effected without departing from the spirit and scope hereof. It is to be understood that no limitation with respect to the specific apparatus illustrated herein is intended or should be inferred. It is, of course, intended to cover by the appended claims all such modifications as fall within the scope of the claims. Further, logic flows depicted in the figures do not require the particular order shown, or sequential order, to achieve desirable results. Other steps may be provided, or steps may be eliminated, from the described flows, and other components may be add to, or removed from the described embodiments.

1. An apparatus comprising:
a coil including a pair of working conductors on opposing longitudinal sides of the coil and respective end conductors that join opposing ends of the working conductors wherein each opposing end of the working conductors has an offset joggle that joins the working conductor to the end conductor.

2. The apparatus as in claim 1 further comprising a second, flat coil, wherein the offset joggle on each end of the working conductors allows a deeply nested coil array in motors and generators, where the offset joggle at each end of every other coil allows the coil array to nest in such a way that the working lengths of each coil lay in a common plane.

3. The apparatus as in claim 1 wherein the coil with the joggles and the flat coil further comprise a motor.

4. An apparatus comprising:
a rotor; and
a stator including a coil array that further comprises:
first and second sets of coils, each including a pair of working conductors on opposing longitudinal sides of the coil and respective end conductors that join opposing ends of the working conductors, the first and second sets of coils arranged along a surface of the rotor in a partially overlapping relationship with mutually parallel working conductors and with each of the working conductors of the second set of coils disposed between and in a common plane with the pairs of working conductors on opposing sides of each of a pair of directly adjacent coils of the first set of coils, each of the working conductors of the second set of coils has a joggle on opposing ends of the working conductors, the joggle offsets the respective ends of each of the second set of coils thereby allowing the respective end conductors of the first set of coils to have clearance from the respective end conductors of the directly adjacent coils of the first of coils and wherein the stator is free of any required saturable magnetic circuit elements.

5. The apparatus as in claim 4 wherein the first set of coils each individually occupy a single plane.

6. The apparatus as in claim 4 wherein the joggles on the ends of the working conductors further comprise two or more bends at selected angles.

7. The apparatus as in claim 4 wherein the rotor and stator further comprises a pancake motor.

8. The apparatus as in claim 7 further comprising a synchronous electric motor or generator.

9. The apparatus as in claim 7 wherein the working conductors of the first and second set of coils all lie within a single plane.

10. The apparatus as in claim 4 wherein the rotor further comprises a cylindrical shape and the stator further comprises an annulus.

11. An apparatus comprising:
a rotor; and
a stator without any required saturable magnetic circuit elements, the stator including a coil array, the coil array further comprising:
a first plurality of coils each coil defined by conductors residing within a single plane, the first plurality of coils are arranged side-by-side with an outer periphery of one coil directly adjacent an outer periphery of an adjacent coil; and
a second plurality of coils, each of the coils of the second plurality of coils are arranged to overlap a respective set of two directly adjacent coils of the first plurality of coils, wherein each of the first and second plurality of coils each include a pair of working conductors on opposing longitudinal sides of the coil and a pair of end conductors that each join respective opposing ends of the working conductors, each of the second plurality of coils include a respective joggle on each of the opposing ends of the working conductors, transverse to the end conductors, wherein the joggles on opposing ends of each of the working conductors join the respective working conductors to the end conductors.

12. The apparatus as in claim 11 wherein the rotor further comprises a substantially flat disk with a drive shaft extending transversely through a center of the flat disk.

13. The apparatus as in claim 12 wherein coils of the stator further comprises an annulus concentric with the drive shaft.

14. An apparatus comprising:
an actuator; and
a stator without any required saturable magnetic circuit elements, the stator including a coil array, the coil array including a first plurality of coils adjacent the actuator each coil defined by conductors residing within a single plane, the first plurality of coils are arranged side-by-side with an outer periphery of one coil directly adjacent an outer periphery of an adjacent coil and a second plurality of coils, each of the coils of the second plurality of coils are arranged to overlap a respective set of two directly adjacent coils of the first plurality of coils, wherein each of the first and second plurality of coils each include a pair of working conductors on opposing longitudinal sides of the coil and a pair of end conductors that each join respective ends of the working conductors, each of the second plurality of coils include a respective joggle on each of the opposing ends of the working conductors thereby providing a deeply nested coil array where selected surfaces of the working lengths of each coil are substantially located in a respective common plane.

15. An apparatus comprising:
a first plurality of substantially planar coils where each of the coils has a plurality of interconnected members and where each plurality of interconnected members bounds a first commonly shaped internal open region;
a second plurality of coils wherein each member of the second plurality has a plurality of interconnected members where each plurality of interconnected members bounds a second commonly shaped internal open region, and where each such member of the second plurality defines spaced apart, nesting facilitating joggles, and, wherein a member of the second plurality extends, in part, into the first commonly shaped region of a member of the first plurality defining a common plane across selected surfaces of each.

16. An apparatus as in claim 15 where another member of the second plurality extends, in part into the first commonly shaped region of the member of the first plurality defining a common plane across selected surfaces of each.

17. An apparatus as in claim 16 comprising one of a motor or a generator having a stator formed of members of the second plurality nested in internal regions of members of the first plurality wherein joggles of each member of the second plurality provide an offset relative to a rotor.

18. An apparatus as in claim 17 where the stator comprises one of a substantially planar, or a cylindrical shape.

19. An apparatus as in claim 18 where each member of the second plurality nests in two different members of the first plurality.

20. An apparatus as in claim 19 where portions of each pair of members of the first plurality and a nesting member of the second plurality define a common plane.
